(19) United States
(12) Patent Application Publication
(10) Pub. No.: US 2006/0260478 A1
(43) Pub. Date: Nov. 23, 2006

(54) Juice maker structure

(76) Inventor: Tony Hsu, Yung Kang City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/132,383

(22) Filed: May 19, 2005

(51) Int. Cl. A47J 43/14

(52) U.S. Cl. 99/495

(57) ABSTRACT

A juice maker structure includes a main body, a feeder and a stud. The feeder is seated on the top of the main body. The feeder is a hollow body having an inner wall. The stud is inserted into the feeder. The inner wall of the feeder is provided with a guiding trough to receive an auxiliary cutter set therein. The lower section of the auxiliary cutter set is provided with cutters facing the inside of the feeder. The outer wall of the stud is provided with a slot to accommodate the cutters. When the stud is pushed to squeeze vegetables, the cutters hold the vegetables in the feeder to process juice making. After using, the auxiliary cutter set can be detached from the guiding trough to be cleaned.

### BACKGROUND OF THE INVENTION

1. Field of the Invention

This invention relates to a juice maker structure, more particularly, to a feeder provided with an auxiliary cutter set to hold vegetables in the feeder for processing.

2. Description of the Related Prior Art

A conventional juice maker on the market is to connect a hollow feeder to a top cover. Food are chopped into small pieces, placed into the feeder and pushed down by a stud to process. The stud comprises a circular rib at the upper section to stop the stud at the opening of the. feeder when operating the juice maker.

Due to this straight push operation, vegetables may slip away at the beginning of operation, and small particles staying around the comer within the feeder may be missed.

Some designs are provided with a strip in the inner wall of the feeder to hold the vegetables inside the feeder. This makes the cleaning of the feeder difficult.

### SUMMARY OF THE INVENTION

It is the primary object of the present invention to provide a juice maker structure, which can squeeze all vegetables in the feeder thoroughly.

It is another object of the present invention to provide a juice maker structure, which is easy to operate.

It is a further object of the present invention to provide a juice maker structure, which is easy to clean and to maintain.

### BRIEF DESCRIPTION OF THE DRAWINGS

FIG. 1 is an exploded view of the present invention;

FIG. 2 is a side view of the present invention, partially sectioned; and

FIG. 3 is a side view showing the present invention in operation.

### DETAILED DESCRIPTION OF THE PREFERRED EMBODIMENT

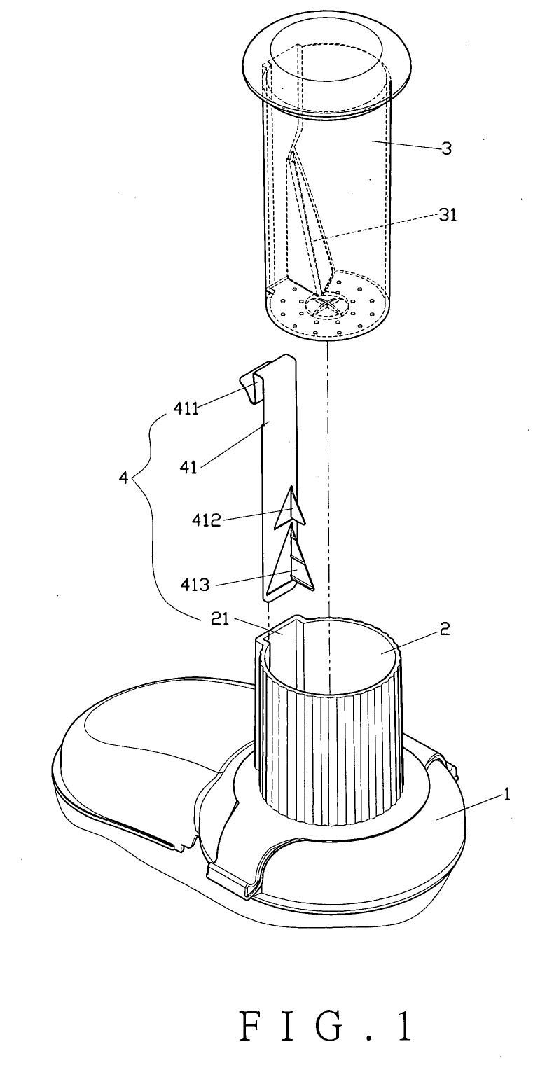

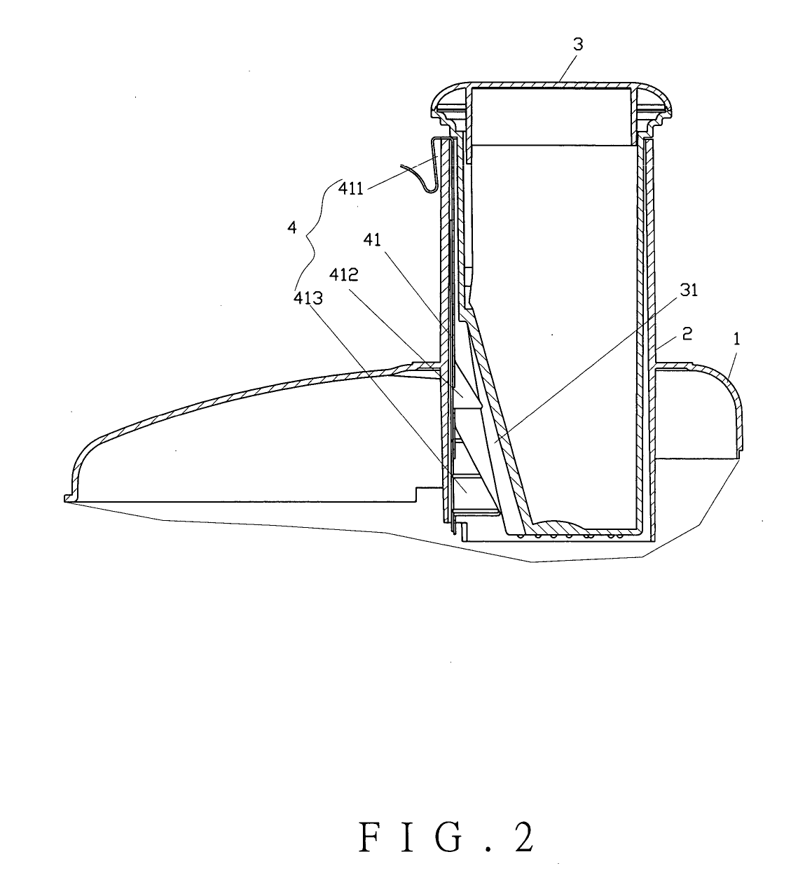

As shown in FIGS. 1 and 2, the present invention comprises a main body 1, a feeder 2, and a stud 3. The feeder 2 is seated on the top of the main body 1. The feeder 2 is a hollow body having an inner wall. The stud 3 is inserted into the feeder 2.

The inner wall of the feeder 2 is provided with a guiding trough 21. An auxiliary cutter set 4 is provided in the guiding trough 21. The auxiliary cutter set 4 is a plate 41 to be inserted in the guiding trough 21. The plate 41 comprises a clip 411 at the upper section thereof to secure the plate 41 in the feeder 2. The lower section of the plate 41 is provided with a smaller cutter 412 and a larger cutter 413 facing the inside of the feeder 2. Each of the cutters 412 and 413 is a slanting plate having a smaller upper portion and a larger lower portion. The smaller cutter 412 is at an upper position and the larger cutter 413 is at a lower position thereof. The stud 3 comprises a slot 31 at the outer wall to accommodate the cutters 412 and 413 therein when the stud 3 is pushed into the feeder 2.

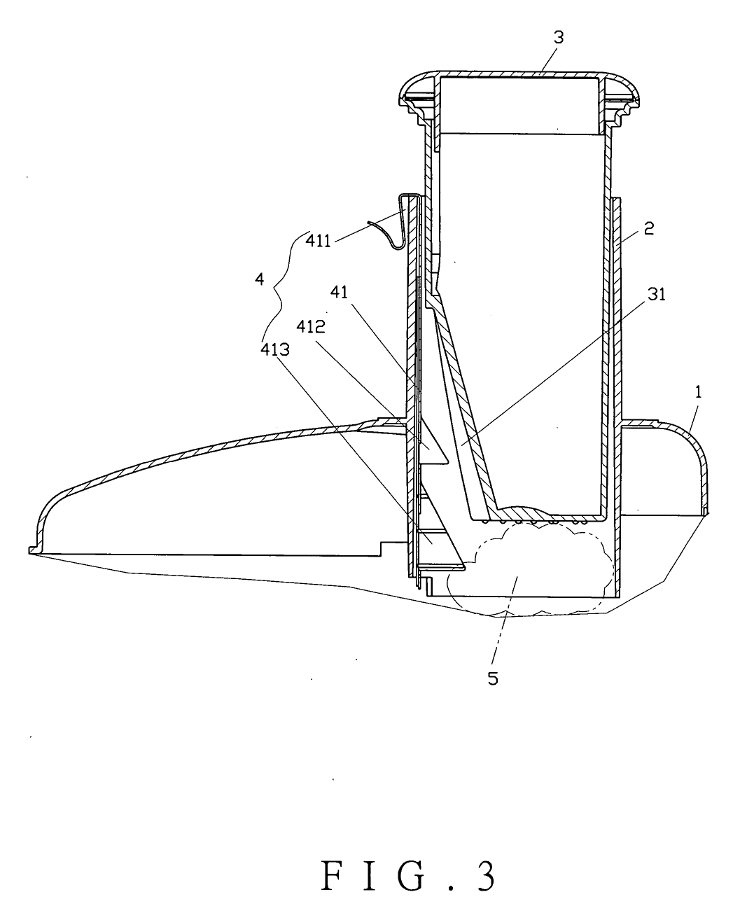

To operate the present invention, as shown in FIG. 3, vegetables 5 are placed into the feeder 2, and the stud 3 is pushed into the feeder 2 to squeeze the vegetables 5 downwardly with the cutters 412 and 413 holding the vegetables 5 to process juice making.

After using, the auxiliary cutter set 4 can be detached from the guiding trough 21 of the feeder 2 and cleaned thoroughly.

What is claimed is:

1. A juice maker structure comprising a main body, a feeder and a stud, said feeder seated on said main body being a hollow body having an inner wall, said stud being inserted into said feeder, and characterized in that:
said feeder comprising a guiding trough at the inner wall for an auxiliary cutter set to be inserted thereat, said auxiliary cutter set comprising cutters at a lower section facing the inside of said feeder, said stud comprising a slot at an outer wall to accommodate said cutters therein.

2. The juice maker structure, as recited in claim 1, wherein said auxiliary cutter set is a plate to be inserted into said guiding trough of said feeder.

3. The juice maker structure, as recited in claim 2, wherein said plate of said auxiliary cutter set comprises a clip at an upper section.

4. The juice maker structure, as recited in claim 1, wherein each of said cutters of said auxiliary cutter set is a slanting plate having a smaller upper portion and a larger lower portion.
